(19) United States
(12) Patent Application Publication
(10) Pub. No.: US 2008/0047408 A1
(43) Pub. Date: Feb. 28, 2008

(54) Wafer dividing method

(75) Inventors: Ryugo Oba, Tokyo (JP); Hiroshi Morikazu, Tokyo (JP); Kenji Furuta, Tokyo (JP); Yohei Yamashita, Tokyo (JP)

Correspondence Address: SMITH, GAMBRELL & RUSSELL, 1130 CONNECTICUT AVENUE, N.W., SUITE 1130, WASHINGTON, DC, 20036, US

(73) Assignee: Disco Corporation

(21) Appl. No.: 11/892,150

(22) Filed: Aug. 20, 2007

(30) Foreign Application Priority Data
Aug. 25, 2006 (JP) 2006-228832

(51) Int. Cl. B26D 3/00

(52) U.S. Cl. 83/39

(57) ABSTRACT

A method of dividing a wafer having devices in areas sectioned by lattice pattern-like streets on the front surface and a metal layer formed on the rear surface along the streets, comprising the steps of cutting the wafer with a cutting blade from the front surface side along the streets to form a cut groove, leaving behind a remaining portion having a predetermined thickness from the rear surface; and applying a laser beam along the cut groove formed by the above cut groove forming step to cut the remaining portion and the metal layer.

### FIELD OF THE INVENTION

The present invention relates to a method of dividing a wafer having devices in areas sectioned by lattice-like streets on the front surface and a metal layer formed on the rear surface, along the streets.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer, and a device such as IC or LSI is formed in each of the sectioned areas. A semiconductor wafer having a metal layer (thickness of 1 to 10 μm) made of lead or gold on the rear surface of a wafer to improve the electric properties of devices is implemented. Individual semiconductor chips are manufactured by cutting this semiconductor wafer along the streets to divide it into the areas each having a device formed therein.

The semiconductor wafer is generally divided along the streets by using a cutting machine called “dicer”. This cutting machine comprises a chuck table for holding a semiconductor wafer as a workpiece, a cutting means for cutting the semiconductor wafer held on the chuck table, and a moving means for moving the chuck table and the cutting means relative to each other as disclosed by JP-A 2002-359212. The cutting means comprises a rotary spindle which is rotated at a high speed and a cutting blade mounted on the spindle. The cutting blade comprises a disk-like base and an annular cutting edge which is mounted on the side wall peripheral portion of the base and formed by fixing diamond abrasive grains having a diameter of about 3 μm to the base by electroforming.

Meanwhile, as a means of dividing a plate-like workpiece such as a semiconductor wafer, JP-A 10-305420 discloses a method comprising applying a pulse laser beam along streets formed on a workpiece to form laser-processed grooves and dividing the workpiece along the laser-processed grooves by a mechanical breaking apparatus.

When a semiconductor wafer having a metal layer made of lead or gold, formed on the rear surface is cut with the cutting blade of a cutting machine, the service life of the cutting blade is shortened by the clogging of the cutting blade and the upper and lower parts of the cut portion are chipped due to increased cutting resistance, thereby reducing the quality of each device.

Meanwhile, when a laser-processed groove is formed by applying a pulse laser beam along the streets of the semiconductor wafer by use of a laser beam processing machine, there is a problem that debris are produced by the application of the laser beam to the semiconductor wafer and adhere to the surface of a device to reduce the quality of the device. Therefore, to form the laser-processed groove along the streets of the semiconductor wafer, a protective film is formed on the front surface of the semiconductor wafer in advance and a laser beam is applied to the semiconductor wafer through this protective film. As a result, the step of forming the protective film on the front surface of the semiconductor wafer must be added, thereby reducing productivity.

### SUMMARY OF THE INVENTION

It is an object of the present invention to provide a method of dividing a wafer along streets without producing chippings of the cut surface or debris adhering to the surface of a device.

To attain the above object, according to the present invention, there is provided a method of dividing a wafer along the streets, where the wafer have devices formed in areas sectioned by lattice pattern-like streets on the front surface and a metal layer formed on the rear surface comprising the steps of:

a cut groove forming step for cutting the wafer with a cutting blade from the front surface side along the streets to form a cut groove, leaving a remaining portion having a predetermined thickness from the rear surface; and

a cutting step for applying a laser beam along the cut groove formed by the above cut groove forming step to cut the remaining portion and the metal layer.

In the above cut groove forming step, the thickness of the remaining portion remaining on the rear surface side of the wafer is preferably set to 50 to 100 μm.

The width of the cut groove formed in the above cut groove forming step is set larger than the spot diameter of a laser beam applied in the above cutting step.

According to the wafer dividing method of the present invention, since the cut groove is formed by cutting with the cutting blade from the front side along the streets in the cut groove forming step, leaving behind the remaining portion having a predetermined thickness from the rear surface, the metal layer is not cut with the cutting blade. Therefore, the clogging of the cutting blade does not occur. Consequently, a reduction in the service life of the cutting blade caused by clogging can be suppressed, and cutting resistance does not increase, thereby making it possible to prevent the upper and lower parts of the cut portion from being chipped. Since a laser beam is applied along the cut groove to cut the remaining portion and the metal layer in the cutting step, debris are produced by the application of a laser beam but the debris scatter in the groove and do not adhere to the surface of a device. Consequently, the protective tape does not need to be formed on the front surface of the wafer.

### BRIEF DESCRIPTION OF THE DRAWINGS

FIG. 1 is a perspective view of a semiconductor wafer as a wafer to be divided by the wafer dividing method of the present invention;

FIG. 2 is an enlarged sectional view of the semiconductor wafer shown in FIG. 1;

FIGS. 3(a) and 3(b) are explanatory diagrams of the wafer supporting step for putting the semiconductor wafer shown in FIG. 1 on the front surface of a dicing tape mounted on an annular frame;

FIG. 4 is a perspective view of the principal portion of a cutting machine for carrying out the cut groove forming step in the wafer dividing method of the present invention;

FIG. 5 is an explanatory diagram of the cut groove forming step in the wafer dividing method of the present invention;

FIG. 6 is an enlarged sectional view of the semiconductor wafer which has undergone the cut groove forming step shown in FIG. 5;

FIG. 7 is a perspective view of the principal portion of a laser beam processing machine for carrying out the cutting step in the wafer dividing method of the present invention;

FIG. 8 is an explanatory diagram of the cutting step in the wafer dividing method of the present invention; and

FIG. 9 is an enlarged sectional view of the semiconductor wafer which has undergone the cutting step shown in FIG. 8.

### DETAILED DESCRIPTION OF THE PREFERRED EMBODIMENTS

A preferred embodiment of the present invention will be described in detail hereinunder with reference to the accompanying drawings.

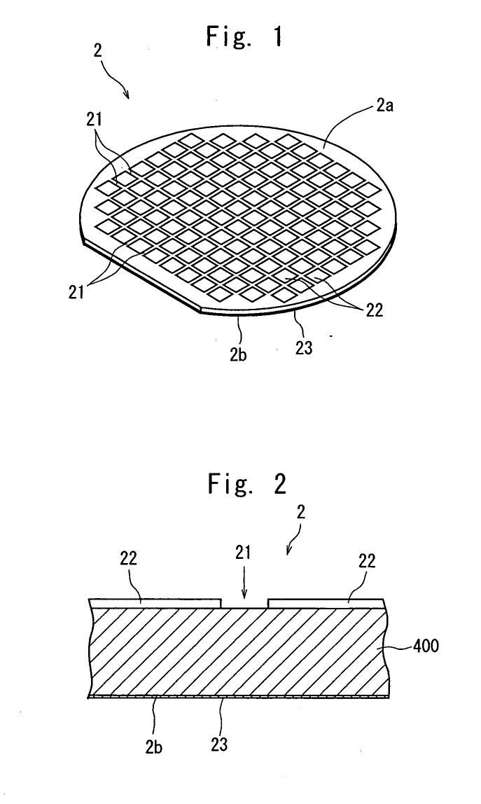

FIG. 1 is a perspective view of a semiconductor wafer as a wafer. The semiconductor wafer 2 shown in FIG. 1 is, for example, a silicon wafer having a thickness of 400 μm, and a plurality of streets 21 are formed in a lattice pattern on the front surface 2a. A device 22 such as IC or LSI is formed in a plurality of areas sectioned by the plurality of streets 21 arranged in a lattice pattern on the front surface 2a of the semiconductor wafer 2. A metal layer 23 made of lead or gold is formed by metal deposition on the rear surface 2b of the semiconductor wafer 2 thus formed. The thickness of the metal layer 23 is set to 5 μm in the illustrated embodiment.

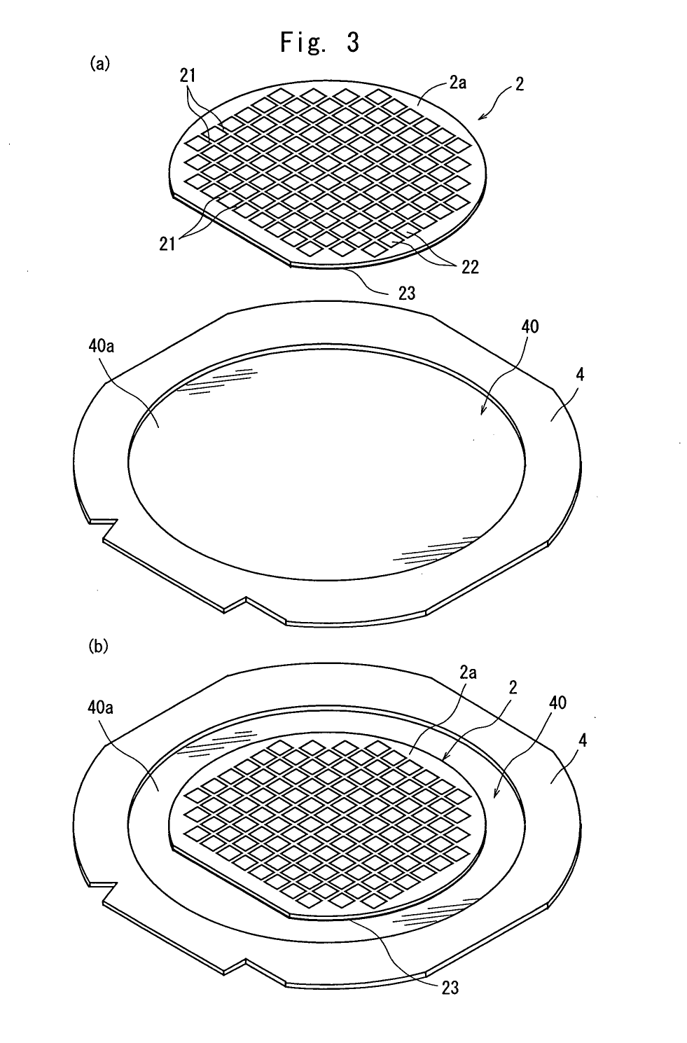

As shown in FIGS. 3(a) and 3(b), the metal layer 23 side laminated on the rear surface 2b of the semiconductor wafer 2 is first put on the front surface 40a of a dicing tape 40 whose outer peripheral portion is mounted on an annular frame 4 to cover its inner opening (wafer supporting step). In the above dicing tape 40, an acrylic resin-based adherent layer is coated on the surface of a sheet material having a thickness of 80 μm and made of polyvinyl chloride (PVC) in the thickness of about 5 μm in the illustrated embodiment.

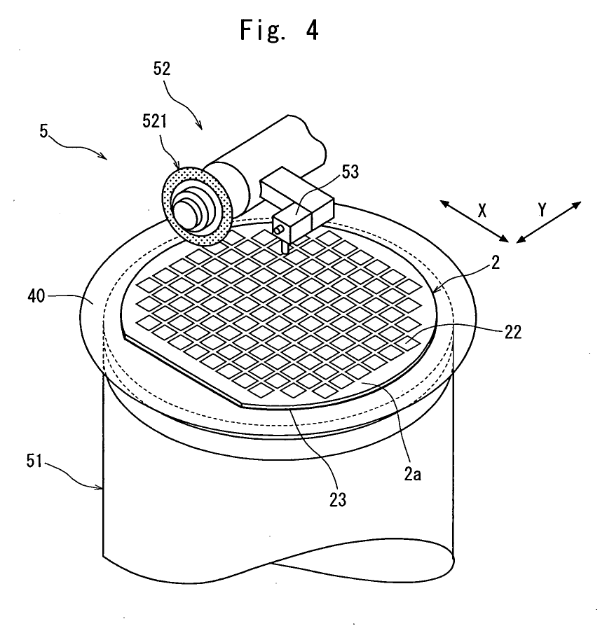

The above wafer supporting step is followed by the step of forming a cut groove by cutting the wafer 2 put on the dicing tape 40 with a cutting blade along the streets 21, leaving behind a remaining portion having a predetermined thickness from the rear surface 2b. This cut groove forming step is carried out by using a cutting machine 5 shown in FIG. 4. The cutting machine 5 shown in FIG. 4 comprises a chuck table 51 for holding a workpiece, a cutting means 52 having a cutting blade 521 for cutting the workpiece held on the chuck table 51, and an image pick-up means 53 for picking up an image of the workpiece held on the chuck table 51. The chuck table 51 is designed to suction-hold the workpiece and to be moved in a processing-feed direction indicated by an arrow X and an indexing-feed direction indicated by an arrow Y in FIG. 4 by a moving mechanisms that is not shown. The cutting blade 521 comprises a disk-like base and an annular cutting edge mounted on the side wall peripheral portion of the base and formed by fixing diamond abrasive grains having a diameter of about 3 μm by electroforming. The above image pick-up means 53 is constituted by an ordinary image pick-up device (CCD), etc. for picking up an image with visible radiation in the illustrated embodiment and supplies an image signal to a control means that is not shown.

To carry out the cut groove forming step by using the cutting machine 5 constituted as described above, the dicing tape 40 to which the wafer 2 is affixed in the above wafer supporting step is placed on the chuck table 51. By activating a suction means (not shown), the wafer 2 is held on the chuck table 51 through the dicing tape 40. Although the annular frame 4, on which the dicing tape 40 has mounted, is not shown in FIG. 4, the annular frame 4 is held by a suitable frame holding means provided on the chuck table 51. The chuck table 51 suction-holding the semiconductor wafer 2 as described above is brought to a position right below the image pick-up means 53 by a cutting-feed mechanism.

After the chuck table 51 is positioned right below the image pick-up means 53, an alignment step for detecting the area to be cut of the semiconductor wafer 2 is carried out by the image pick-up means 53 and the control means that is not shown. That is, the image pick-up means 53 and the control means (not shown) carry out image processing such as pattern matching, etc. to align a street 21 formed in a predetermined direction of the semiconductor wafer 2 with the cutting blade 521, thereby performing the alignment of the area to be cut (aligning step). The alignment of the area to be cut is also carried out on streets 21 formed on the semiconductor wafer 2 in a direction perpendicular to the above predetermined direction.

After the alignment of the area to be cut is carried out by detecting the street 21 formed on the semiconductor wafer 2 held on the chuck table 51 as described above, the chuck table 51 holding the semiconductor wafer 2 is moved to the cut start position of the area to be cut. At this point, the semiconductor wafer 2 is positioned such that one end (left end in FIG. 5) of the street 21 to be cut is located on the right side a predetermined distance from a position right below the cutting blade 521, as shown in FIG. 5. The cutting blade 221 is then moved down (cutting-in fed) by a predetermined distance as shown by a solid line in FIG. 5 from a stand-by position shown by a two-dotted chain line by a cutting-in feed mechanism while it is rotated at a predetermined revolution in a direction indicated by an arrow 521a in FIG. 5. This cutting-in feed position is set, for example, to a position 135 μm above a standard position where the outer periphery end of the cutting blade 521 comes into contact with the front surface of the chuck table 51 in the illustrated embodiment. Since the thickness of the dicing tape 40 is set to 80 μm in the illustrated embodiment, the outer periphery end of the cutting blade 521 passes a position 55 μm above the front surface of the dicing tape 40. Therefore, as the 5 μm-thick metal layer 23 is formed on the rear surface 2b of the semiconductor wafer 2, the outer periphery end of the cutting blade 521 passes a position 50 μm above the rear surface 2b of the semiconductor wafer 2.

After the cutting blade 521 is moved down (cutting-in fed) as described above, the chuck table 51 is moved in a direction indicated by an arrow X1 in FIG. 5 at a predetermined cutting feed rate while the cutting blade 521 is rotated at the predetermined revolution in the direction indicated by the arrow 521a in FIG. 5. After the right end of the semiconductor wafer 2 held on the chuck table 51 passes a position right below the cutting blade 521, the movement of the chuck table 51 is stopped.

The above groove forming step is carried out under the following processing conditions, for example.

Cutting blade: outer diameter of 52 mm, thickness of 70 μm

Revolution of cutting blade: 40,000 rpm

Cutting-feed rate: 50 mm/sec

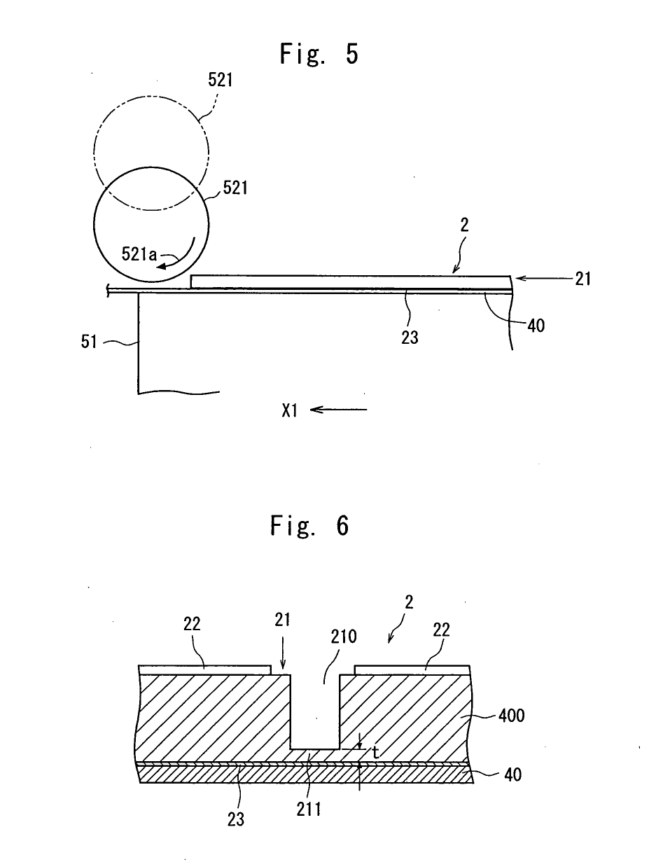

The above groove forming step is carried out on all the streets 21 formed on the semiconductor wafer 2. As a result, a cut groove 210 is formed along the streets 21 in the semiconductor wafer 2, as shown in FIG. 6. This cut groove 210 having a width of 70 μm and a depth of 350 μm is formed under the above processing conditions. Therefore, a remaining portion 211 having a thickness (t) of 50 μm from the bottom of the cut groove 210 formed along the streets 21 to the rear surface 2b is left behind. The width of the cut groove 210 is set larger than the spot diameter of a laser beam applied in the cutting step that will be described later. The thickness (t) of the remaining portion 211 formed along the streets 21 of the semiconductor wafer 2 is preferably 50 to 100 μm. That is, when the thickness (t) of the remaining portion 211 is smaller than 50 μm, the semiconductor wafer 2 may be broken during transfer, and when the thickness (t) of the remaining portion 211 is larger than 100 μm, a load in the cutting step described later becomes large.

Since the cut groove 210 is formed without reaching the metal layer 23 formed on the rear surface 2b of the semiconductor wafer 2 in the above cut groove forming step, the clogging of the cutting blade 521 does not occur. Therefore, a reduction in the service life of the cutting blade 521 caused by clogging can be suppressed and cutting resistance does not increase, thereby making it possible to prevent the upper and lower parts of the cut portion from being chipped.

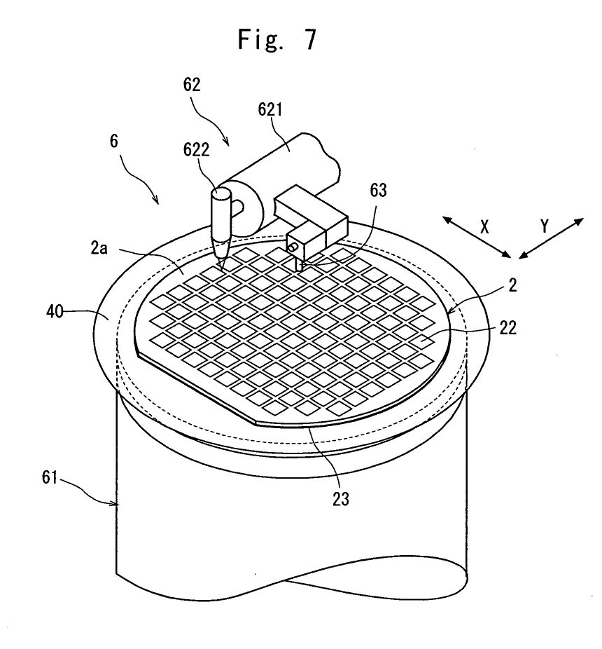

After the above cut groove forming step, next comes the step of cutting the above remaining portion 211 and the metal layer 23 by applying a laser beam along the cut grooves 210. This cutting step is carried out by using a laser beam processing machine 6 shown in FIG. 7. The laser beam processing machine 6 shown in FIG. 7 comprises a chuck table 61 for holding a workpiece, laser beam application means 62 for applying a laser beam to the workpiece held on the chuck table 61, and an image pick-up means 63 for picking up an image of the workpiece held on the chuck table 61. The chuck table 61 is designed to suction-hold the workpiece and to be moved in a processing-feed direction indicated by an arrow X and an indexing-feed direction indicated by an arrow Y in FIG. 7 by a moving mechanism that is not shown.

The above laser beam application means 62 comprises a cylindrical casing 621 arranged substantially horizontally. In the casing 621, there is installed a pulse laser beam oscillation means (not shown) which comprises a pulse laser beam oscillator composed of a YAG laser oscillator or YVO4 laser oscillator and a repetition frequency setting means. A condenser 622 for converging a pulse laser beam oscillated from the pulse laser beam oscillation means is mounted on the end of the above casing 621. The image pick-up means 63 mounted on the end portion of the casing 621 constituting the laser beam application means 62 is constituted by an ordinary image pick-up device (CCD), etc. for picking up an image with visible radiation in the illustrated embodiment and supplies an image signal to a control means that is not shown.

To carry out the cutting step for cutting the above remaining portion 211 and the metal layer 23 by applying a laser beam along the cut grooves 210 to the semiconductor wafer 2 which has undergone the above cut groove forming step with the above laser beam processing machine 6, the dicing tape 40, to which the side of the metal layer 23 formed on the rear surface 2b of the semiconductor wafer 2 is affixed, is placed on the chuck table 61. By activating a suction means (not shown), the semiconductor wafer 2 is held on the chuck table 61 through the dicing tape 40. Although the annular frame 4, on which the dicing tape 40 is mounted, is not shown in FIG. 7, the annular frame 4 is held by a suitable frame holding means provided on the chuck table 61. The chuck table 61 suction-holding the semiconductor wafer 2 is brought to a position right below the image pick-up means 63 by a moving mechanism that is not shown.

After the chuck table 61 is positioned right below the image pick-up means 63, alignment work for detecting the area to be processed of the semiconductor wafer 2 is carried out by the image pick-up means 63 and the control means that is not shown. That is, the image pick-up means 63 and the control means (not shown) carry out image processing such as pattern matching, etc. to align a street 21 (where the cut groove 210 is formed) formed in a predetermined direction of the semiconductor wafer 2 with the condenser 622 of the laser beam application means 62 for applying a laser beam along the street 21, thereby performing the alignment of a laser beam application position (aligning step). The alignment of the laser beam application position is also carried out on streets 21 (where the cut groove 210 is formed) formed on the semiconductor wafer 2 in a direction perpendicular to the above predetermined direction.

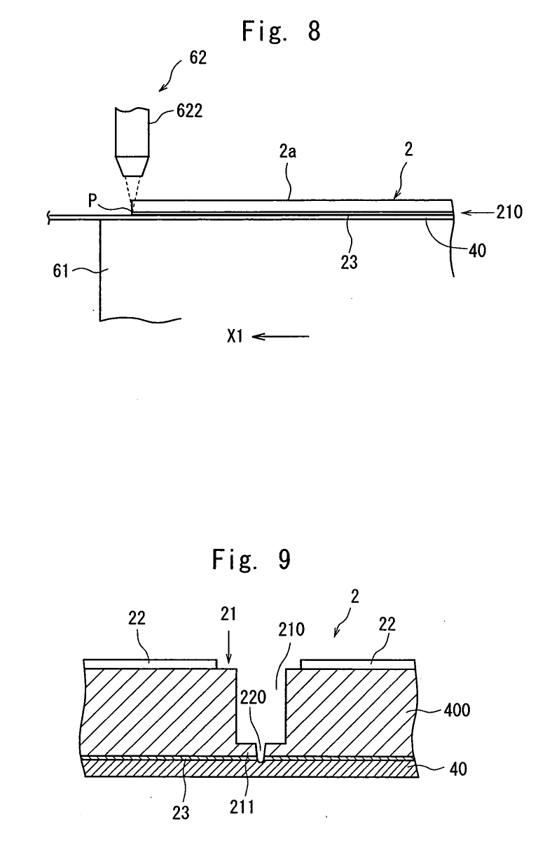

After the alignment of the laser beam application position is carried out by detecting the street 21 (where the cut groove 210 is formed) formed on the semiconductor wafer 2 held on the chuck table 61 as described above, the chuck table 61 is moved to a laser beam application area where the condenser 622 of the laser beam application means 62 is located so as to bring one end (left end in FIG. 8) of the cut groove 210 formed in the predetermined street 21 to a position right below the condenser 622 of the laser beam application means 62, as shown in FIG. 8. The chuck table 61 is then moved in the direction indicated by the arrow X1 in FIG. 8 at a predetermined processing-feed rate while a pulse laser beam of a wavelength having absorptivity for a silicon wafer is applied from the condenser 622. When the application position of the condenser 622 of the laser beam application means 62 reaches the other end (right end in FIG. 8) of the cut groove 210 formed in the street 21, the application of the pulse laser beam is suspended and the movement of the chuck table 61 is stopped. At this point, the focal point P of the pulse laser beam applied from the condenser 622 is set to a position near the bottom surface of the cut groove 210.

The above cutting step is carried out under the following processing conditions, for example.

Light source of laser beam: YVO4 laser or YAG laser

Wavelength: 355 nm

Repetition frequency: 10 kHz

Average output: 1.5 W

Focal spot diameter: 10 μm

Processing-feed rate: 150 mm/sec

By repeating the above cutting step three times under the above processing conditions, a cut groove 220 is formed in the above remaining portion 21 and the metal layer 23 to cut them as shown in FIG. 9. Although debris are produced by irradiation of a pulse laser beam in this cutting step, the debris scatter in the cut groove 210 and do not adhere to the surface of a device 22. Therefore, it is not necessary to form a protective film on the front surface of the semiconductor wafer 2. By carrying out the above cutting step on all the streets 21 formed on the semiconductor wafer 2, the semiconductor wafer 2 is divided into individual semiconductor chips (devices).

What is claimed is:

1. A method of dividing a wafer along the streets, where the wafer have devices formed in areas sectioned by lattice pattern-like streets on the front surface and a metal layer formed on the rear surface comprising:
a cut groove forming step for cutting the wafer with a cutting blade from the front surface side along the streets to form a cut groove, leaving a remaining portion having a predetermined thickness from the rear surface; and
a cutting step for applying a laser beam along the cut groove formed by the above cut groove forming step to cut the remaining portion and the metal layer.

2. The wafer dividing method according to claim 1, wherein the thickness of the remaining portion remaining on the rear surface side of the wafer in the cut groove forming step is set to 50 to 100 μm.

3. The wafer dividing method according to claim 1, wherein the width of the cut groove formed in the cut groove forming step is set larger than the spot diameter of a laser beam applied in the cutting step.
